(19) United States
(12) Patent Application Publication
(10) Pub. No.: US 2010/0264069 A1
(43) Pub. Date: Oct. 21, 2010

(54) METHOD AND APPARATUS FOR CLASSIFICATION OF RECYCLED MATERIAL

(75) Inventors: John F. Green, Hampstead, NH (US); Peter Mendre, Haverhill, MA (US); Thomas M. Taylor, Lisle, NY (US)

Correspondence Address: Vern Maine & Associates, 547 AMHERST STREET, 3RD FLOOR, NASHUA, NH, 03063-4000, US

(73) Assignee: JJG IP Holdings, LLC, Hampstead, NH (US)

(21) Appl. No.: 12/762,430

(22) Filed: Apr. 19, 2010

Related U.S. Application Data
(60) Provisional application No. 61/170,720, filed on Apr. 20, 2009.

(51) Int. Cl. B07B 1/15; B07B 1/00; B07B 1/46; F16C 3/00

(52) U.S. Cl. 209/262; 209/392; 464/182

(57) ABSTRACT

A system is provided for sorting solid materials, that system comprising: a plurality of shafts disposed upon bearings, the bearings being fixed on an inclined slope; each shaft of the plurality of shafts being configured with a plurality of sorting discs, the sorting discs being configured with a receiving cavity and material contact fingers; spacers configured to be received by the receiving cavity of the discs and to maintain a desired space between the discs; and the spacers being configured with a hexagonal or pentagonal cross section.

### RELATED APPLICATIONS

This application claims the benefit of U.S. Provisional Application No. 61/170720, filed Apr. 20, 2009. This application is herein incorporated by reference in its entirety for all purposes.

### FIELD OF THE INVENTION

The invention relates to sorting/separation screens, and more particularly, to a sorting screen configured to minimize entanglement of screen components by light debris and the removal of fines.

### BACKGROUND OF THE INVENTION

Unwanted materials may wrap around spacers in separating screens causing a buildup of material and inhibiting the performance of the separation screen. Excessive maintenance is required to remove this unwanted wrapped material from these disc spacers frequently. Excessive need for screen cleaning caused by wrapping of shafts and spacers limits the kinds of materials the screen can process economically. Decreased wrapping enables the separation of more highly contaminated materials including municipal solid waste, commercial waste and construction demolition material as well as decreased maintenance on all recycling applications including Single Stream material.

What is needed therefore is a system wherein highly contaminated materials including single stream, municipal solid waste, construction demolition and industrial dry waste material can be sorted economically and with decreased maintenance.

### SUMMARY OF THE INVENTION

One embodiment of the present invention provides a system for sorting solid materials, that system comprising: a plurality of shafts disposed upon bearings, the bearings being fixed typically but not always on an inclined slope; each shaft of the plurality of shafts being configured with a plurality of sorting discs, the sorting discs being configured with a receiving cavity and material contact fingers; spacers configured to be received by the receiving cavity of the discs and to maintain a desired space between the discs; and the spacers being configured with a non-circular cross section.

Another embodiment of the present invention provides such a system wherein the disc comprises first and second separable sections.

A further embodiment of the present invention provides such a system wherein the spacer comprises first and second separable mating sections.

Yet another embodiment of the present invention provides such a system further comprising a shield disposed at first and second ends of each the shaft.

A yet further embodiment of the present invention provides such a system wherein the sorting discs comprise glass breaking, classification discs.

Still another embodiment of the present invention provides such a system wherein the glass breaking, classifying disc comprises steel.

A still further embodiment of the present invention provides such a system wherein the shaft is a square shaft.

Even another embodiment of the present invention provides such a system wherein the sorting discs comprise a conformable material selected from the group of conformable materials consisting of rubber, silicon, and synthetic materials. In an alternative embodiment, this same screen may be configured with an abrasion resistant steel disc for use in glass breaking and fines removal.

An even further embodiment of the present invention provides such a system wherein the shaft comprises a tubular member, first and second stub shafts disposed in opposing ends of the tubular member; removable fasteners linking the first and second stub shafts to the tubular member.

Yet even another embodiment of the present invention provides such a system wherein each the stub shaft engages a corresponding bearing of the bearings.

A yet even further embodiment of the present invention provides such a system wherein a shield collar is disposed between each the stub shaft and each the corresponding bearing.

Still even another embodiment of the present invention provides such a system further comprising at least one shaft of the plurality of shafts being equipped with extended spacers of equal width to the width of two spacers and a sorting disc.

One embodiment of the present invention provides a solid material sorting disc, the disc comprising: a first and second interlocking sections; the first and second interlocking sections being coupled at a joint perpendicular to first and second faces of the disc; a shaft receiving aperture disposed through the disc, perpendicular to the first and second faces of the disc; a cavity disposed in the first and second faces of the disc about the shaft receiving aperture; the cavity being configured to receive pentagonal or hexagonal disc spacers.

One embodiment of the present invention provides a shaft for a solid material sorting disc, the shaft comprising: a tubular member; a first and second keyed stub shafts configured to be disposed in opposing ends of the tubular member; at least one mechanical fastener coupling each the stub shaft to the tubular member; an outer spacer shield, disposed on a distal end of each the stub shaft; each the stub shaft being configured to be received by a bearing.

Another embodiment of the present invention provides such a shaft wherein the shaft is configured to be encircled by interlocking separator discs.

A further embodiment of the present invention provides such a shaft wherein the shaft is configured to receive hexagonal or pentagonal disc spacers.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a perspective drawing illustrating a materials sorting screen configured in accordance with one embodiment of the present invention.

FIG. 2 is a perspective drawing illustrating a shaft with associated discs and spacers of a materials sorting screen configured in accordance with one embodiment of the present invention.

FIG. 3 is an elevation view illustrating a materials sorting screen configured in accordance with one embodiment of the present invention and having articulating sections.

FIG. 4 is a perspective drawing illustrating the timed relationship between the disc finger and the corresponding flat of the spacer.

FIG. 5 is a perspective drawing illustrating a sorting screen shaft configured for use in a system in accord with one embodiment of the present invention.

FIG. 6 is a detail view of one end of a sorting screen shaft configured use in a system in accord with one embodiment of the present invention.

FIG. 7 is an exploded view of one end of a sorting screen shaft configured for use in a system in accord with one embodiment of the present invention.

FIG. 8 is a top view of a sorting screen configured in accord with one embodiment of the present invention and having a container sorting disc configuration.

### DETAILED DESCRIPTION

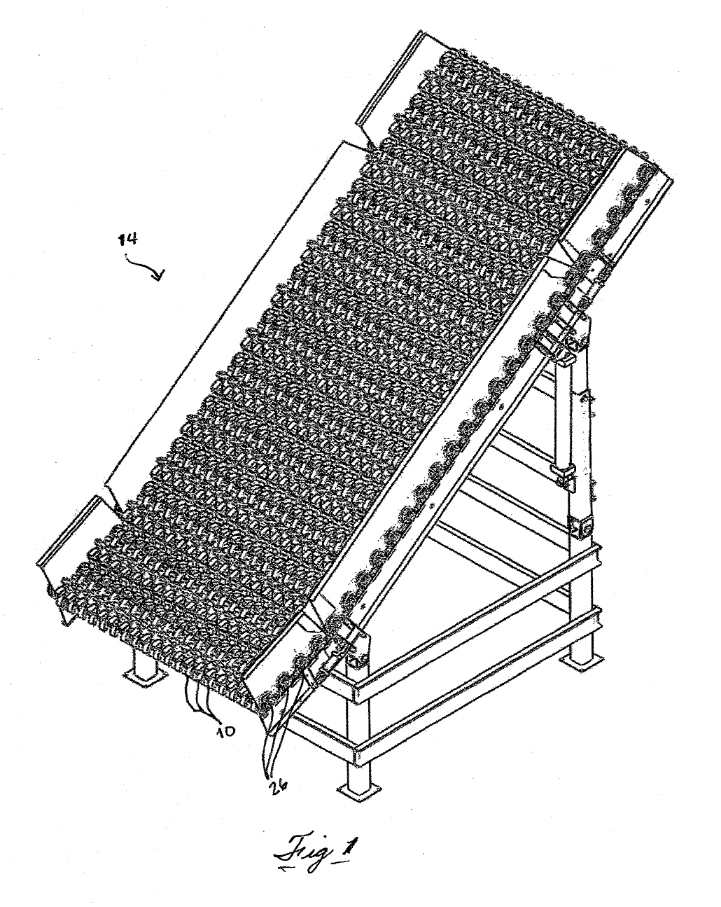

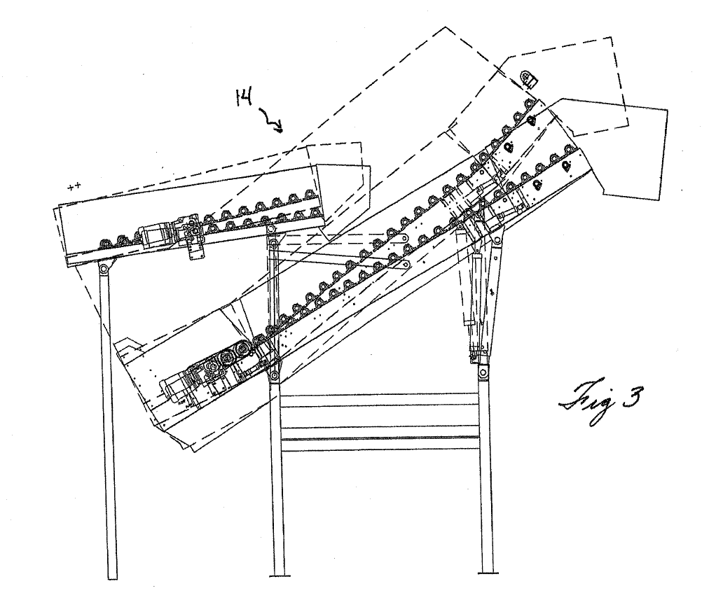

A compound or abrasion resistant steel disc 10 is provided by one embodiment of the present invention, forming part of a plurality of discs mounted to individual shafts 12 within a frame system 14 designed to facilitate the separation of recyclable material by size and consistently or type. A separation screen 14 configured from such discs is illustrated in FIG. 1. As illustrated in FIG. 1, the separation screen 14 may be configured with a plurality of articulation points or hinged breaks in the screen whereby the position and angle of the screen may be change. In one embodiment hydraulic cylinders may be provided to hydraulically adjust the position of screen in relation. This is illustrated with greater clarity in FIG. 3.

As noted in the background, the inventor has identified through the sale and maintenance of those sorting screens the need to develop a recycling screen spacer that is resistant to material wrapping around their rotating shafts. Some embodiments of such a separation screen systems, such as that illustrated in FIG. 3 will be provided with an optional fines and glass removal screen that is sometimes integrally connected to the separation screen. Such a fines and glass screen will include the same anti wrapping spacer technology described herein and would be integrally attached to a separation screen configured according to the embodiments of the present invention. Such a fines screen would articulate with the separation screens angle adjustments. As the separation screen angle inclination is raised and lowered the fines screen angle follows. Such a design enables the fines screen to follow the separation screen at an adjustable ratio. This design allows for the automatic adjustment of the fines screen throughput. Typically as the separation screen angle is inclined the throughput lowers but the separation improves. The same principle applies to the fines screen as the screen is inclined the material resides on the screen longer and obtains better fines and glass removal rates. Competitors fines and glass screens are fixed and do not follow this automatic variable adjustment.

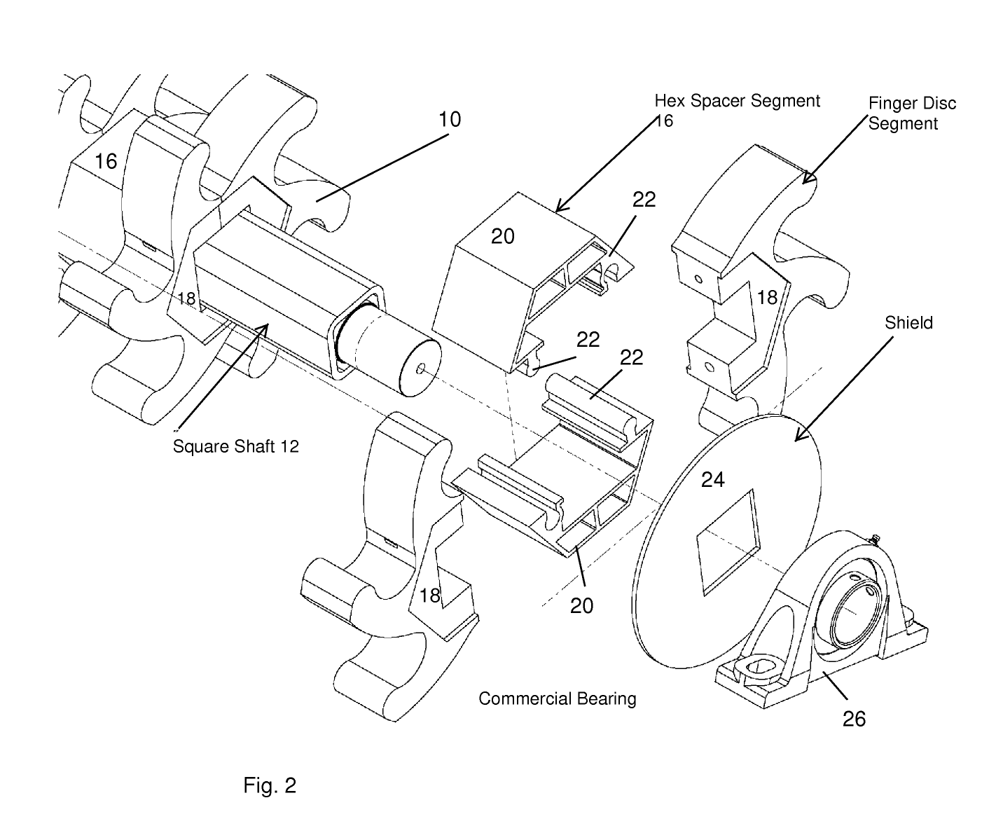

One embodiment of the present invention provides hexagonal or pentagon spacers 16 which may be disposed between discs 10 in the plurality of discs configured so as to not wrap as much as known spacer configurations. An embodiment of the present invention employing such hexagonal or pentagonal spacers 16 is illustrated in FIG. 2. These polyhedral spacers 16 allow processing of materials with higher levels of contaminants with reduced maintenance and production time. Compound rubber discs or abrasion resistant glass breaking and debris fines removal steel discs 10 are positioned between the spacers 16, and are subject to wear requiring periodic replacement. It is faster to remove the individual worn discs 10 without the removal of the entire shaft 12. Such exchanges are facilitated by providing a disc having two or more pieces which can be separated and removed. The compound disc 10 of one embodiment of the present invention may be indented with a receiving cavity 18 configured to match the spacer 16 thereby enabling the spacer 16 to fit neatly within the disc cavity 18. This design enables the removal of the split compound disc 10 without removing the spacer 16. The neatly fitted discs indentation or receiving cavity 18 discourages the wrapping or wedging of materials between the compound disc 10 and spacer 16. The removal of two or more compound discs 10 allows a spacer 16 disposed between those two discs 10 to also be split. In one embodiment of the present invention, sections 20 of the spacer 16 may be separated by sliding the two sections 20 in opposite directions, disengaging complementary locking components 22, again without the removal of the shaft. An alternative embodiment of the present invention allows spacer removal with the removal of one disc when coupled with a bolt together spacer design. Both designs facilitate in field adjustments to the disc spacing without the removal of the shafts or entire screen, thus drastically reducing adjustment time or the need to replace the screen.

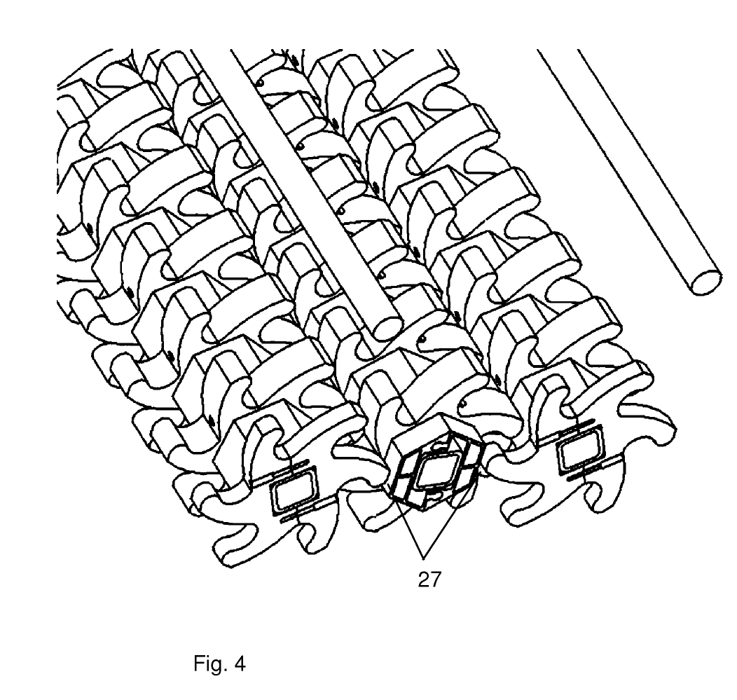

In one embodiment illustrated in FIG. 2, a hexagonal or pentagonal shaped spacer 10 is provided with a split design such as that described above, and is comprised of sections 20 to enable its removal from an inner shaft 12 and to facilitate its coincidence with the timing of fingers 27 of the compound disc 10, illustrated in FIG. 4, where facilitating a close tolerance between the tips of the figures and the flat of the hexagonal shaft 12 thus limiting the possibility of a jamb. A close tolerance maintained between the fingers and the flats of the spacers and the additional agitation of the peaks of the spacers greatly diminishes the likelihood of material wrapping on the discs. The flat sides of the spacer thus correspond with the fingers, and one skilled in the art will appreciate that the number of figures on the disc will correspond in such embodiments with the number of sides for the hexagonal or pentagonal spacer disc. Hexagonal or pentagonal spacers limit material wrapping and increase agitation of material to be separated. Composite rubber or Steel discs 10 are provided creating friction whereby lighter materials are made to climb an adjustable inclined deck 14. These discs 10 are spaced to allow desired material to climb screen, fall between discs and roll off the tail of the screen 14. Indented receiving cavities 18 in the sides of each spacer 16 allow each spacer 16 to neatly fit inside of disc 10 and discourage material from lodging between the disc 10 and spacer 16. Outer spacer shields 24, in some embodiment of the present invention, may be positioned on each end of the screen shaft limits materials migration onto shaft 12 and bearings 26. In one embodiment of the present invention, pillow block bearings may be used. In one embodiment, 3″ square shafts 12 are reduced to a round shape with a step design at each end to facilitate the outer spacer shield 24 and then reduced down again to accommodate pillow block bearing 26 thus eliminating possible shifting and wrapping of shafts 12. The entire screen deck, as illustrated in FIG. 1 is designed to have an adjustable incline. The upper and lower portions of the screen deck have added adjustability independent of the main deck. The design according to one embodiment of the present invention has an adjustable lower deck area that allows for less fiber and other contaminants to discharge with the desired containers.

The variable fines screen option available on separation screen enhances fines removal and increases the breaking of impact susceptible materials for separation and removal from the waste stream, such as “glass”.

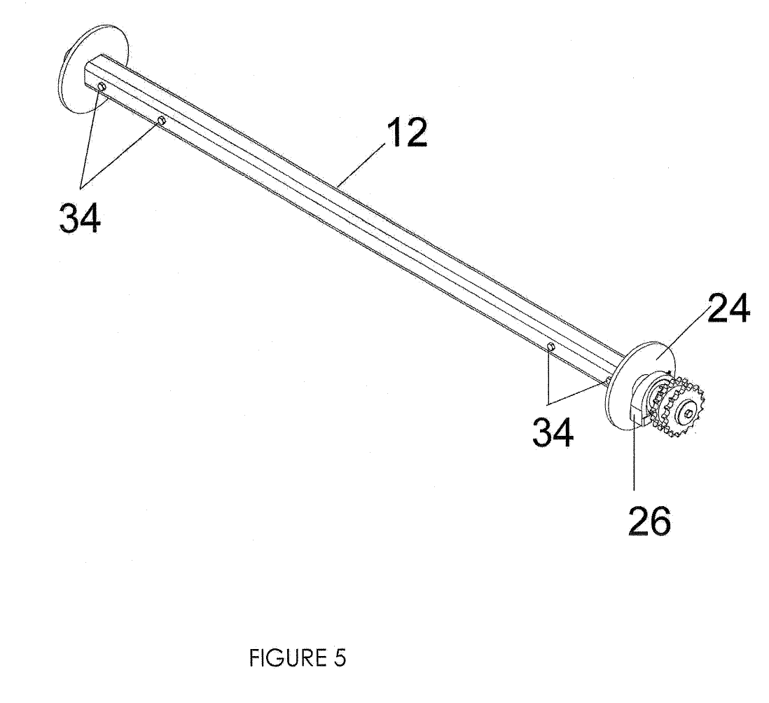

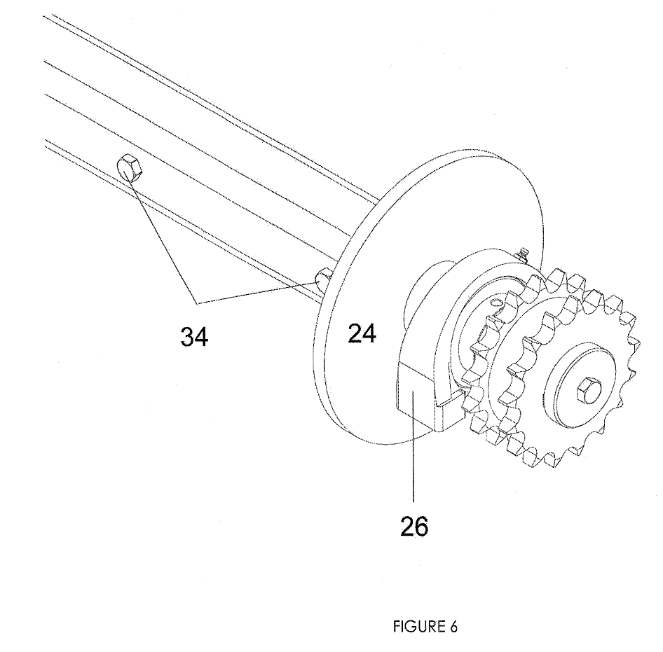

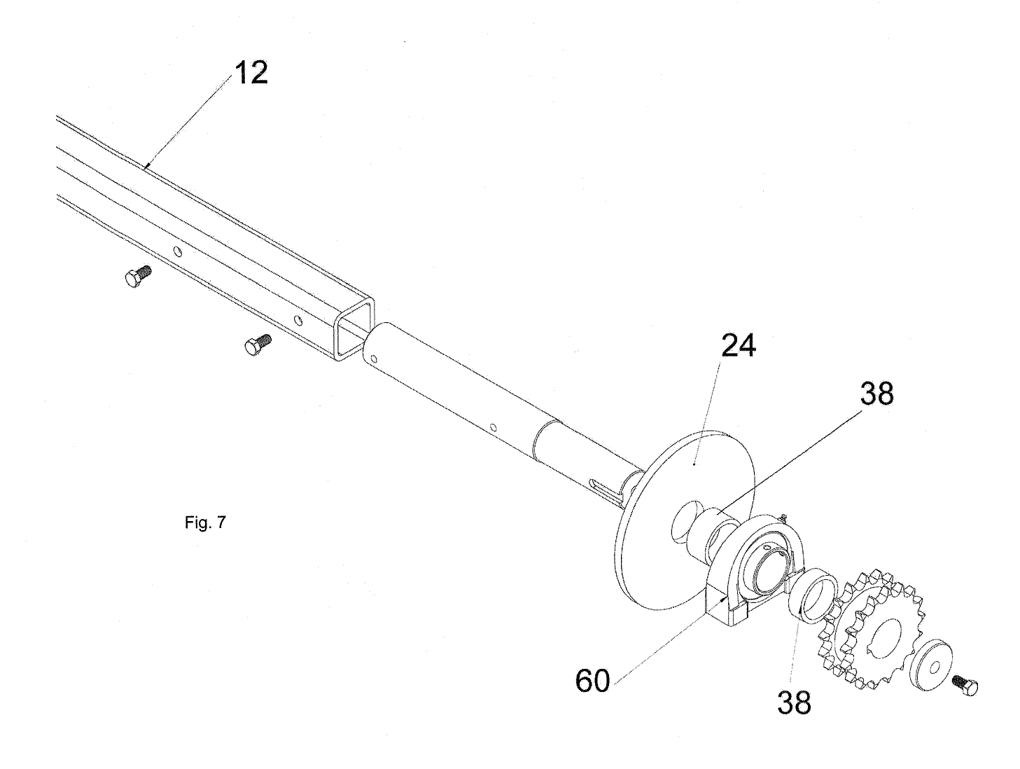

In one embodiment of the present invention, the screen is provides with a removable stub shaft 30 facilitating removal and replacement of the stub shaft 30 in the event that it is damaged. Damage to the stub shaft 30 may result from bearing seizure or bending of the stub shaft due to the presence of heavy loads. As replacement of the shaft 12 upon which the discs 10 and separators 16 are disposed is difficult, removable and replaceable stub shafts 30 allow an operator to replace the stub shaft 30 and the bearings 26 without having to remove the entire shaft 12. The shaft 12 of one such embodiment is illustrated in FIGS. 5-7. In this embodiment, the shaft 12 is a tube of square cross section within which is disposed a keyed stub shaft 30. The stub shaft 30 and the shaft 12 are coupled by means of a mechanical fastener 34, in one embodiment the mechanical fastener 34 is a hex head screw. One skilled in the art will appreciate that other removable fasteners would also be suitable. Shields 24 and spacers 38 may be disposed as necessary to protect the bearings 26.

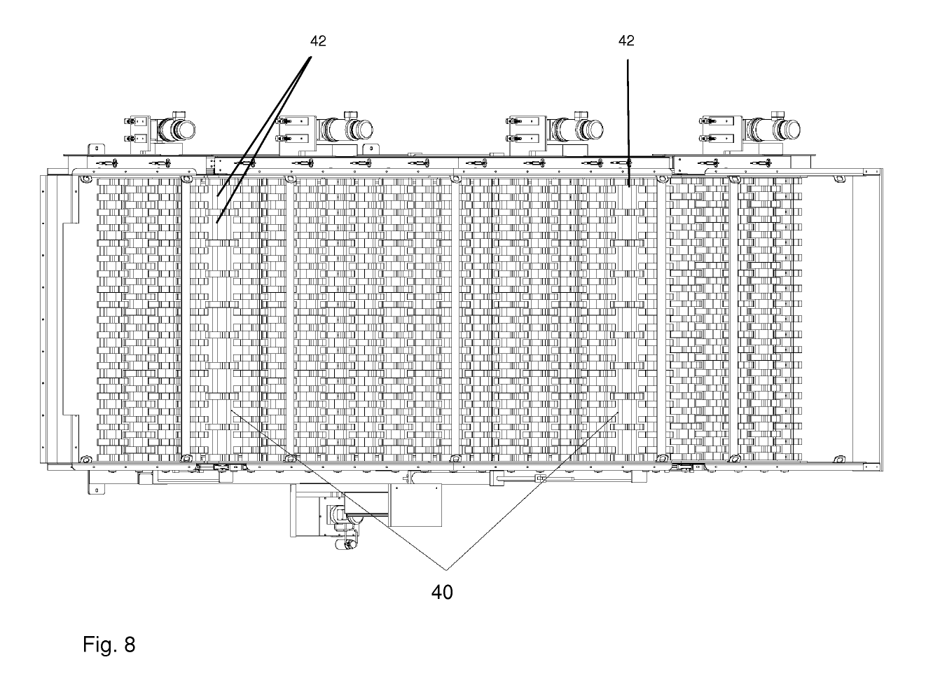

In one embodiment, illustrated in FIG. 8, one or more shafts 40 from the plurality of shafts 12 making up the screen are configured with fewer discs. This reduced disc shaft 40 is configured as other shafts 12, but with elongated spacers 42, such that the discs are spaced at twice the interval of discs on other shafts 12. Such elongated spacers have a width equal to two spacers 16 and a sorting disc 10 at the point where the spacers 16 contact the sorting disc 10. Such a configuration allows for improved separation of container waste, often damaged or crushed into quasi-two dimensional shapes from true two dimensional waste, by allowing container waste to pass through gaps in the screen formed by the “missing discs”.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but nor by the example claims appended hereto.

We claim:

1. A system for sorting solid materials, the system comprising:
a plurality of shafts disposed upon bearings, said bearings being fixed on an inclined slope;
each shaft of said plurality of shafts being configured with a plurality of sorting discs, said sorting discs being configured with a receiving cavity and material contact fingers;
spacers configured to be received by said receiving cavity of said discs and to maintain a desired space between said discs; and
said spacers being configured with a pentagonal or hexagonal cross section.

2. The system of claim 1 wherein said disc comprises first and second separable sections.

3. The system of claim 1 wherein said spacer comprises first and second separable mating sections.

4. The system according to claim 1 further comprising a shield disposed at first and second ends of each said shaft.

5. The system of claim 1 wherein said sorting discs comprise glass breaking discs.

6. The system of claim 5 wherein said glass breaking disc comprises steel.

7. The system of claim 1 wherein said shaft is a square shaft.

8. The system according to claim 1 wherein said sorting discs comprise a conformable material selected from the group of conformable materials consisting of rubber, silicon, and synthetic materials.

9. The system according to claim 1 wherein said shaft comprises a tubular member, first and second stub shafts disposed in opposing ends of said tubular member; removable fasteners linking said first and second stub shafts to said tubular member.

10. The system according to claim 9 wherein each said stub shaft engages a corresponding bearing of said bearings.

11. The system according to claim 10 wherein a shield collar is disposed between each said stub shaft and each said corresponding bearing.

12. The system according to claim 1 further comprising:
at least one shaft of said plurality of shafts being equipped with extended spacers of equal width to the width of two spacers and a sorting disc.

13. A solid material sorting disc, said disc comprising:
a first and second interlocking sections;
said first and second interlocking sections being coupled at a joint perpendicular to first and second faces of said disc;
a shaft receiving aperture disposed through said disc, perpendicular to said first and second faces of said disc;
a cavity disposed in said first and second faces of said disc about said shaft receiving aperture;
said cavity being configured to receive pentagonal or hexagonal disc spacers.

14. A shaft for a solid material sorting disc, said shaft comprising:
a tubular member;
a first and second keyed stub shafts configured to be disposed in opposing ends of said tubular member;
at least one mechanical fastener coupling each said stub shaft to said tubular member;
an outer spacer shield, disposed on a distal end of each said stub shaft;
each said stub shaft being configured to be received by a bearing.

15. The shaft according to claim 14 wherein said shaft is configured to be encircled by interlocking separator discs.

16. The shaft according to claim 14 wherein said shaft is configured to receive hexagonal or pentagonal disc spacers.
